(19) United States
(12) Patent Application Publication
(10) Pub. No.: US 2019/0036695 A1
(43) Pub. Date: Jan. 31, 2019

(54) METHOD FOR SECURE AUTHENTICATION IN DEVICES CONNECTABLE TO A SERVER, PARTICULARLY IN ACCESS CONTROL EQUIPMENT OR AUTOMATED PAYMENT OR VENDING MACHINES OF AN ACCESS CONTROL SYSTEM

(71) Applicant: SKIDATA AG, Grödig/Salzburg (AT)

(72) Inventors: Thomas RIES, Klagenfurt am Wörthersee (AT); Michael GRAFL, Klagenfurt am Wörthersee (AT); Andreasö KERSCHBAUMER, Klagenfurt am Wörthersee (AT)

(21) Appl. No.: 15/996,675

(22) Filed: Jun. 4, 2018

(30) Foreign Application Priority Data
Jul. 25, 2017 (EP) 17182938.5

(51) Int. Cl. H04L 9/32; H04L 9/14; H04L 9/30; H04L 9/08

(52) U.S. Cl. CPC H04L 9/3213; H04L 9/0825; H04L 9/30; H04L 9/14

(57) ABSTRACT

A method for secure authentication in devices (d1) connectable to a server (S), particularly in access control equipment or automated payment or vending machines of an access control system, in the course of which the server (S) generates a separate key pair for asymmetric cryptography, which consists of a public and a private key, for each device (d1) during the registration of the device (d1) on the server and assigns the generated key pair to this device (d1) only, wherein the public key assigned to a device (d1) is transmitted to the device (d1) during the registration of the device (d1) on the server (S), and wherein the authentication during the access to a device (d1) is realized by an access token, which is signed with the private key of the key pair assigned to the device (d1) by the server (S).

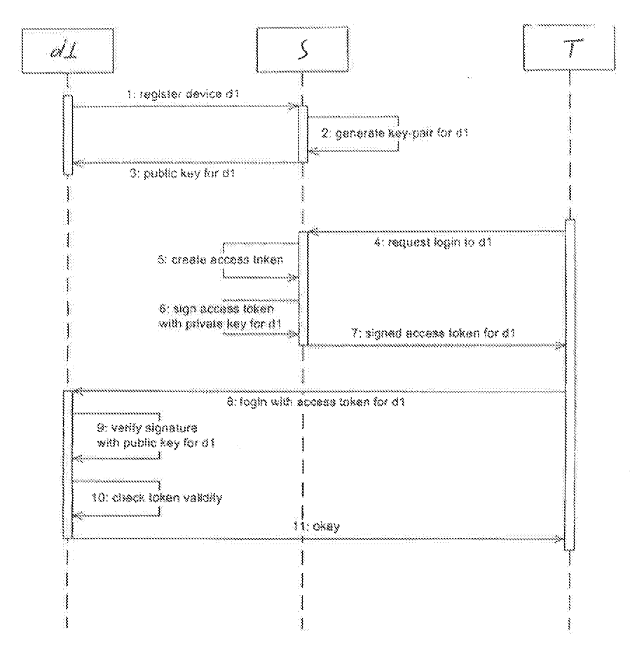

This application claims priority from European patent application serial no. 17182938.5 filed Jul. 25, 2017.

### FIELD OF THE INVENTION

The present invention pertains to a method for secure authentication in devices connectable to a server, particularly in access control equipment or automated payment or vending machines of an access control system.

### BACKGROUND OF THE INVENTION

In a device management system, which comprises multiple devices that can be connected to a server for the purpose of data communication, technicians frequently have to log on to the devices, for example, in order to perform maintenance work. The disadvantage of systems comprising a large number of devices, in particular, can be seen in that it is therefore necessary to manage a considerable amount of access data.

It is known from the prior art to realize the required authentication for accessing a device by means of a password chosen for each individual device. In this case, it is disadvantageous that a large number of passwords has to be chosen and securely stored, which in practical application frequently leads to the selection of weak passwords and also to the exchange of passwords between technicians such that the security is negatively affected. In addition, a recovery of forgotten passwords may have to be carried out, in particular, in devices that only rarely require authentication, e.g. because maintenance work only has to be performed on rare occasions. The two-factor authentication known from the prior art can be used in order to increase the security, but a large number of passwords also has to be disadvantageously managed in this case.

The authentication may furthermore be realized by casus of a so-called Full Scale Public Key Infrastructure (PKI) based on certificates. In this case, each technician has a digital certificate that may be stored, for example, on a smart card and ensures access to the devices. In this case, the certificate has to be issued by a certification authority and provided with a digital signature. In order to use these methods, the root certificate of the certification authority has to be installed on each device. A person skilled in the art is quite familiar with such methods.

If certificates are revoked before their validity expires, for example, upon termination of a working relationship for security reasons, correspondingly updated certificate revocation lists have to be transmitted to all devices. This in turn means that a device has to be connected to a server of the certification authority after a certificate has been revoked in order to prevent unauthorized access to the device. The transmission and management of the certificate revocation lists disadvantageously increased the complexity of the software installed on the devices arid requires a high storage capacity.

If a root certificate has to be revoked, e.g. because the root certificate was compromised, it has to be disadvantageously revoked on all devices, which in turn leads to the invalidation of all certificates issued so far on all devices.

### SUMMARY OF THE INVENTION

The present invention is based on the objective of disclosing a method for secure authentication in devices connectable to a server, particularly in access control equipment or automated payment or vending machines of an access control system, by means of which the complexity of PKI methods can be avoided. In addition, the necessity to manage a large number of passwords should be eliminated.

This objective is attained with the characteristics of the independent claim(s). Other advantageous embodiments can be gathered from the dependent claims.

Accordingly, the invention proposes a method for secure authentication in devices connectable to a server, particularly in access control equipment or automated payment or vending machines of an access control system, in the course of which the server generates a separate key pair for asymmetric cryptography, which consists of a public and a private key, for each device during the registration of the device on the server and assigns the generated key pair to this device only, wherein the public key assigned to a device is transmitted to the device during the registration of the device on the server, and wherein the authentication during the access to a device is realized by means of an access token, which is signed with the private key of the key pair assigned to the device by the server.

In contrast to a Full Scale Public Key Infrastructure (PKI), the public key of the device is neither signed by the server nor by a certification authority.

Due to the inventive concept, the necessity to manage certificate revocation lists is eliminated. Since a key pair consisting of a public and a private key is assigned to each device, the security of other devices is not affected if the private key of a device comes to be known. The necessity to revoke a certificate by a certification authority is therefore advantageously eliminated.

The method specifically comprises the following steps: during the registration of a device on the server, e.g. a device management server, a private and a public key for asymmetric cryptography are generated by the server and assigned to this device only, wherein the public key is stored on the device and the private key is stored on the server.

When a person such as a technician wants to access a device, this person has to request an access token for a certain device from the server. In this case, the server generates an access token, wherein the access token is signed with the private key assigned to this device by the server and transmitted to the technician. In other embodiments, the access token may also be stored on a USB stick, on a chip card or on another storage medium. The respective person must be able to access the server in order to request an access token.

According to an enhancement of the invention, the access token may also contain additional information or parameters with respect to the granted access to the device, e.g. a validity period and/or a validity for a predefined number of logins and/or a validity for defined actions.

The technician transmits the access token to the device, which verifies the signature of the access token in the form of the private key of the device based on the public key of the key pair assigned so and stored on this device, wherein the validity of the access token is checked after the signature has been verified and access to the device is granted upon confirmation of the validity, if applicable in accordance with potential additional validity information or parameters contained in the access token.

Access to the device is denied if the signature cannot be verified or if it is determined that the access token is invalid after the signature has been verified. An access token may be invalid, for example, if it has expired or was revoked. In this way, access to the devices can be realized flexibly in dependence on the persons who are granted access and/or the security guidelines for each device. The devices feature storage means and the corresponding software and have the required computing capacity.

The inventive authentication tor accessing a device, e.g. in order to grant a technician access to a device tor local maintenance work, has the advantage that the device being accessed does not have to be connected to the server because only the public key, which in accordance with the invention is stored on the device, is required for the verification of an access token.

According to an enhancement of the invention, the server may transmit a timestamp to the device, wherein the device stores and uses this timestamp for the validity check of the access token in addition to the system time of the device. This measure increases the security because the invalidity of a token is detected based on the timestamp, namely even if the system time of the device was manipulated in accordance with the validity date of the expired access token. The transmission of the timestamp may take place when the connection between a device and the server is established or within regular or irregular intervals.

According to an enhancement of the invention, a server may transmit a list containing the expired or revoked access tokens for a device to this one device. This measure increases the security because the invalidity of an access token is defected based on the list, namely even if the system time of the device was manipulated in accordance with the validity date of the expired access token. Since a separate key pair is assigned to each device, another advantage can be seen in that the list of expired or revoked access tokens has to be transmitted to one device only such that the network load and storage requirement for the other devices are significantly reduced.

In order to renew the key pair assigned to a device, a new key pair is generated by the server, wherein the new public key is transmitted to the device when this device is connected to the server. In this case, the new key pair replaces the old key pair. The generation of a new key pair can advantageously replace the revocation of one or more access tokens because the existing access tokens become invalid due to the signature of the existing access tokens with the no longer valid private key. The renewal of the key pair assigned to a device does not affect the key pairs assigned to the other devices.

### BRIEF DESCRIPTION OF THE DRAWING

An example of the invention is described in greater detail below with reference to the sole FIGURE, which shows a sequence diagram for elucidating the registration of a device and the generation and use of an access token.

### DETAILED DESCRIPTION OF THE PREFERRED EMBODIMENTS

In the attached FIGURE, the reference symbol T identifies a technician, wherein a device connectable to a server is identified by the reference symbol d1 and a server is identified by the reference symbol S. The device d1 may consist, for example, of access control equipment of an access control system, e.g. an access control system in a skiing area or an automated payment or vending machine.

At the beginning of the method, the device d1 registers with the server S (step 1). In the context of the invention, the registration is a registration in accordance with the implementation of the inventive method. In this case, the server S generates a private and a public key for asymmetric cryptography (step 2), which are assigned to this device d1 only, wherein the public key is transmitted to and stored on the device d1 (step 3). The private key is stored on the server S.

In step 4, a technician T requests an access token for the device d1 from; the server 3, wherein the server S subsequently generates an access token (step 5), which is signed with the private key for this device d1 by the server S (step 6) and transmitted to the technician T (step 7).

In order to log on to the device d1 and carry out an authentication, the access token is transmitted to the device d1 (step 8), wherein the device d1 verifies the signature of the transmitted access token in the form of the private key of the device d1 based on the public key stored on the device d1 (step 9), and wherein the validity of the access token is checked (step 10) after the signature tea been verified and access to the device d1 is granted (step 11) upon confirmation of the validity.

1-8. (canceled)

7. A method for secure authentication in devices connectable to a server, particularly in access control equipment or automated payment or vending machines of an access control system, the method comprising:
generating, via the server (S), a separate key pair for asymmetric cryptography which consists of a public and a private key for each device (d1), during registration of the device (d1) with the server (S), and assigns the generated key pair only to this device (d1),
transmitting the public key, assigned to a device (d1), to the device (d1) during the registration of the device (d1) on the server (S), and
realizing the authentication, during access to a device (d1), by an access token which is signed with the private key of the key pair assigned to the device (1) by the server (S).

8. The method for secure authentication in devices (d1) connectable to the server (S) according to claim 7, further comprising providing the access token with additional information or parameters with respect to the granted access to the device (d1).

9. The method for secure authentication in devices (d1) connectable to the server (S) according to claim 7, further comprising transmitting the access token to the device (d1) in order to be granted access,
verifying, via the device (d1), a signature of the transmitted access token in the form of the private key of the device (d1) based on the public key stored on the device (d1), and checking the validity of the access token after the signature is verified, and
granting access to the device (d1) upon confirmation of the validity.

10. The method for secure authentication in devices (d1) connectable to the server (S) according to claim 7, further comprising, in the case of expired or revoked access tokens for a device (d1), transmitting, via the server (S), a list containing the expired or revoked access tokens for the device (d1) to this device (d1).

11. The method for secure authentication in devices (d1) connectable to the server (S) according to claim 7, further comprising generating, via the server (S), a new key pair, which replaces an old key pair, in order to renew the key pair assigned to a device (d1), and
transmitting the new public key to the device (d1).

12. The method for secure authentication in devices (d1) connectable to the server (S) according to claim 7, further comprising using a timestamp, which is transmitted by the server (S) and stored on the device (d1), for checking a validity period of the issued access tokens in addition to a local system time of the device (d1).
